(19) United States
(12) Patent Application Publication
(10) Pub. No.: US 2024/0189738 A1
(43) Pub. Date: Jun. 13, 2024

(54) Method And Device For Crystallising And Separating Substances

(71) Applicant: I-aim-I GmbH, Troisdorf (DE)

(72) Inventors: Shangli Cheng, Niederkassel (DE); Bo Cheng, Aachen (DE)

(73) Assignee: I-aim-I GmbH, Troisdorf (DE)

(21) Appl. No.: 18/286,546

(22) PCT Filed: Mar. 31, 2022
(86) PCT No.: PCT/EP2022/058646

§ 371 Date: Oct. 11, 2023

(30) Foreign Application Priority Data
Apr. 16, 2021 (BE) BE2021/5303

(51) Int. Cl. B01D 9/00; B01D 9/02

(52) U.S. Cl. CPC B01D 9/0036; B01D 9/0063; B01D 9/02

(57) ABSTRACT

The present invention relates to a crystallisation method and a crystallisation arrangement for crystallising a substance from a solution, in particular for resolution of racemates.

The present invention relates to a method and a device for crystallizing and separating substances from a mixture of substances, in particular from a supersaturated solution of the mixture of substances.

In many areas, it is advantageous to crystallize defined substances from a solution in order to isolate these substances, especially in pure form. One example is enantiomer separation, in which the different enantiomers must be separated from a mixture of enantiomers, at best in enantiomerically pure form. Enantiomer separation is used, for example, in the production of active pharmaceutical agents. It is thus evident that safe and effective enantiomer separation is often of fundamental importance.

With regard to known methods for the crystallization of defined substances from solutions, for example for the separation of enantiomers, a wide variety of solutions already exists in the prior art.

For example, Xichong Ye et al, Enantiomer-selective magnetization of conglomerates for quantitative chiral separation, Nature Communications, (2019)10:1964 (https://doi.org/10.1038/s41467-019-09997-y,), describes a method for separating crystals from conglomerates by using magnetic splitting through enantiomer-selective magnetization. However, this method has the following disadvantages. The magnetic splitters used are made of co-polymer with an enantiomerically pure substance as an auxiliary. The polymer and the magnetic particles as matrix for the experiment have to be prepared in several steps, over several days, under temperatures ranging from below 0° C. to 300° C. The subsequent separation processes take another several days.

US 2019/0345098 A1 describes the separation of enantiomers from a racemic mixture by processes of so-called preferential crystallization. In this process, the enantiomers are obtained by selective crystallization processes with seed crystals.

Andrew S. Dunn et al, Resolution control in a Continuous Preferential Crystallization Process, Organic Process Research & Development, DOI: 10.1021/acs.oprd.9b00275, also describes a process of preferential crystallization to separate enantiomers.

US 2012/0197040 A1 also describes the separation of a racemic mixture. At least two crystallization units are used to crystallize at least one enantiomer in one crystallization unit.

AT 357501 describes a process and a device for removing excess salts, in particular tartar and calcium salts, from beverages. In this process, the beverage is brought into contact with crystals in order to crystallize out the excess salts. The crystals may be fixed to carrier surfaces. The method and apparatus serve for removing solids from a solution, where the crystallized salts are not a pure substance, but a mixture of several different substances. Therefore, the disclosure of the present document is suitable for the preparation of a salt-free beverage, but not for separation of a pure crystal solid from a solution.

U.S. Pat. No. 2,994,593 describes a crystallization device designed to arrange a large number of seed plates in a small volume.

U.S. Pat. No. 2,495,024 describes a crystallization device to grow crystals from supersaturated solutions.

JPS4940234 A describes a crystallization process using seed crystal carriers.

Basically, the principle of preferential crystallization, known per se, concerns the use of a seed crystal, which is formed either by addition into a solution or by excess of an enantiomer of a racemate in the solution before the start of crystallization. In the prior art as mentioned above, seed crystals floating in the solution are used in particular. The seed crystals are suspended in the solution by stirring. In order to obtain the distribution of seed crystals as homogeneous as possible in the solution and also to avoid sedimentation on the bottom of the containers, the stirring speed should be optimized according to the size of the particle and should still be adjusted during the process, since crystals grow to some extent. At a high stirring speed, the goal of dispersion can be achieved, but large flow intensity leads to breakage of crystals by collision with crystals, with the walls of the vessel or with the stirrer, and thus to high secondary seed formation. The resulting fine crystals have a broad Gaussian distribution of the size of the particle, which makes it difficult to separate the solid product from the solution in subsequent workup. This is because a high content of the solution and thus more impurities adhere to the crystals, more detergent or more washing processes are required, and a longer drying time is usually necessary. Furthermore, if the crystal product of an active ingredient is used directly for drugs, the different particle sizes can cause different bioavailabilities, which means a reduced usability of the directly resulting product.

The separation of crystals from a solution, for example by filtration or centrifugation, often proves to be very elaborate, since appropriate devices for separating the crystals from the solution have to be provided. In addition, the problem can arise that the solution becomes contaminated again by the crystals when the crystals are separated from it, which is a particular problem when separating mixtures of enantiomers. In particular, if there is a large distribution of crystalline particles, separation of the crystals by filtration, for example, can be problematic.

In the prior art, for isolation after crystallization, the suspension with the produced crystals is transferred to another container where the crystals are separated from the solution, in particular by filtration or centrifugation. In this process, the whole solution must pass through the new container of the filter or through the centrifuge drum. In industrial processes, the suspension is still transferred by the pump and pipeline. Each new contact, for example with the pipeline, the pump, the filter container or the centrifuge drum means additional possible sources of contamination and makes it difficult to control the temperature of the suspension. The process sequence of filtration or centrifugation of the entire suspension also requires a relatively long time.

These three factors, namely new contact surface, longer separation time and decreasing temperature, entail the risk that impurities, in particular due to the corresponding enantiomer antipode, crystallize out during work-up. This is because in the preferred crystallization, the antipode is often also supersaturated in the solution, which is why seed formation is further stimulated by decreasing temperature, contact with new surfaces and/or longer residence time.

In a coupled continuous process, there is an additional problem such that floating fine particles of an enantiomer could be transferred from one process vessel to the other process vessel of the antipode by circulation flow. As results, two different enantiomer antipodes exist in both process vessels, which torpedoes a final enantiomer separation. In this case, the process must be aborted or another step must follow. After aborting, the work-up with the separation of the crystals from the solution and a regeneration to the starting point can take a longer time.

Such solutions known from the prior art are thus not satisfactory in all respects and there is a need for new processes and devices for crystallizing and separating substances from a mixture of substances.

It is therefore an object of the present invention to provide an improved method and device for the crystallization and/or separation of substances from a solution, in particular of enantiomers from a racemic mixture in the solution, which are capable of overcoming at least in part one drawback of the prior art.

According to the invention, the object is solved by a method having the features of claim 1. According to the invention, the object is further solved by a crystallization arrangement having the features of claim 1 land by an arrangement having the features of claim 15. Preferred embodiments of the invention are disclosed in the dependent claims, in the description, in the examples and in the figures, whereby further features described or shown in the dependent claims or in the description or in the figures or in the examples may individually or in any combination constitute an object of the invention, if the opposite does not clearly result from the context.

The present invention relates to a method for crystallizing and separating a substance from a solution in which the substance is present, in particular dissolved supersaturated, comprising the method steps:
a) introducing the solution comprising the substance into a receiving volume of a process vessel of a crystallization arrangement, the solution having a temperature T1 after introduction;
b) providing a crystallization insert with at least one carrier for insertion into the process vessel, wherein the surface of the carrier is provided with seed crystals for the substance for crystal growth in such a way that the seed crystals are immobilized on the surface of the carrier of the crystallization insert, and wherein at least one carrier has a spiral shape,
c) positioning the crystallization insert in a receptacle of the crystallization device in such a way that the carrier can be brought into contact with the solution.
d) optionally, cooling the seed crystals while adjusting the temperature at the seed crystals to a temperature T2, where T2 is lower than T1,
e) crystallization of the substance on the surface of the seed crystals, and
f) optionally, isolating the formed crystals of the substance in the process vessel.

The crystallization method described here thus serves in particular to crystallize a substance from a solution in which the substance is present, in particular in combination with one or more other substances, in order to separate and, optionally, isolate the substance and thus obtain it in particular in pure form. Thus, the crystallization method described herein can in particular be a separation process for separating a mixture of substances.

The method as described herein includes the following method steps.

First, according to method step a), the solution containing the substance is introduced into a receiving volume of a process vessel, which may also be referred to as a separation vessel, of a crystallization device, the solution having a temperature T1 after being introduced into the process vessel. Thus, a solution is introduced into the process vessel, which may be designed as a liquid vessel, the solution comprising the substance to be crystallized and separated or preferably isolated by the method. For example, the substance is dissolved in the solution in a suitable concentration, the substance being present in the solution in particular supersaturated.

The process vessel of the crystallization device is basically selectable, insofar as the method described herein can be carried out with it. Advantageous materials include in particular non-oxidizing materials, such as glass, or non-oxidizing metals, for example stainless steel or enameled metals, or plastic. In principle, the material of the process vessel should be inert to the solution.

Furthermore, the solution has a temperature T1. This temperature T1 is preferably selected so that the substance is completely dissolved in the solution. In this case, the solution can already have the temperature T1 before being introduced into the process vessel, or the temperature T1 can be set after introduction. However, the temperature should be set in particular before method step c).

The temperature T1 of the solution can preferably be at most 20° C., preferably at most 10° C., in particular preferably at most 5° C. below the saturation temperature. In particular, the saturation temperature is present at the conditions in which the solution is present, for example about 1 bar. For example, the temperature T1 may be the saturation temperature and the substance may be present as a saturated solution.

Subsequently, according to method step b), a crystallization insert with at least one carrier is provided for insertion into the process vessel, wherein the surface of the carrier is provided with seed crystals for the substance, for example with seed crystals of the substance, for crystal growth in such a way that the seed crystals are immobilized on the surface of the carrier of the crystallization insert, and wherein at least one carrier has a spiral shape.

The crystallization insert serves to crystallize the substance to be separated from the solution in such a way that the substance crystallizes at the crystallization insert. For this purpose, a carrier is provided which is provided with at least one or, in particular, with a plurality of seed crystals which are adapted to the substance in such a way that the substance can crystallize on the seed crystals. Furthermore, the crystallization insert and the carrier and further the process vessel are configured such that they can be positioned in the receiving volume, optionally in the liquid, which can optionally be located in the receiving volume. In particular, the crystallization arrangement may be formed with a lid for the process vessel and seal the latter in a liquid-tight manner. The lid may thus be replaceable, for example with a filtration insert, as described in more detail below.

For example, the carrier can be part of the crystallization insert or attached or mounted to it. In particular, the carrier or carrier parts can run vertically.

The immobilization of the seed crystals on the surface of the carriers can be achieved, for example, by exposing the carrier to a solution of the corresponding high-purity substance of which the seed crystals are to consist. In particular, the carrier may be immersed in a corresponding supersaturated solution and the carrier may subsequently be dried. It is further possible to spray dry the solution on the carrier, or to wet the carrier with a melt, wherein the carrier can both be immersed in a melt or the carrier can be sprayed or otherwise coated with a melt. Similarly, seeding the carrier with seed crystals may be accomplished by providing the solvent-treated carrier with fine crystallines of the substance with which the carrier is to be seeded, or by basically any other suitable method. The mass of the seed crystals can be varied, for example, by the duration of the immersion or by the duration of the spraying.

The carrier can also be placed in solution and the solution can then be cooled so that seed crystals of the substance form on the carrier.

Furthermore, the carrier can in principle have a selectable shape which is preferably chosen in such a way that a large surface is provided with which seed crystals come into contact with the solution. Furthermore, it is advantageous if the solution can flow through the carrier with the seed crystals, so that a relative movement of the solution relative to the carrier is possible or the solution can flow around the carrier and thus the seed crystals.

The carrier has a spiral shape, whereby in particular an Archimedean spiral shape can be provided. Such a shape is particularly effective for homogeneous distribution of the seed crystals in the solution across the separation, for example when the carrier is rotated in the process vessel or when the carriers are rotated in the process vessel or when the carrier or carriers are stationary in the process vessel, which is supported by the spiral shape of the carrier.

In addition, the carrier may further advantageously be formed at least in part from a material selected from the group consisting of metal, plastic, textile, paper, renewable resource, ceramic, glass, and carbon. Depending on the solvent, these materials may have the advantage of being inert to the solution and may further be well suited to allow seed crystals to settle.

A rough surface or surface with granular substrates favor wetting with the solution and formation of the seed crystals on it. For aqueous solutions, the surface of the substrate with hydrophilic properties is advantageous.

In principle, it may be preferred that the seed crystals are immobilized densely and homogeneously finely distributed. This allows rapid and, in particular, at least largely complete crystallization of the substance on the large surface area of the seed crystals, which can enable an effective and efficient method, as described below.

Accordingly, according to method step c), the crystallization insert is positioned in a receptacle of the crystallization device, such as the process vessel, in such a way that the carrier can be brought into contact with the solution. The bringing together of the crystallization insert or of the carrier and the solution thus takes place, for example, by immersing the carrier in the solution, for example while moving, such as rotating, the carrier in the solution, but can also take place by flowing the solution over the carrier. The latter can be realized, for example, if the carrier is located above the solution when it is stationary and the solution is conveyed, for example, to flow over the carrier.

Accordingly, it is possible in principle that the solution with the substance is first filled into the process vessel and then the carrier is positioned accordingly, or vice versa, or that first part of the solution is filled into the process vessel, then the carrier is positioned accordingly and then a further part of the solution is filled into the process vessel. In this case, the substance may be present only in the first part, only in the further part or in the first part and the further part of the solution. Thus, method step a) can take place at least in part before method step c) or method step a) can take place at least in part after method step c). It is also possible for method step a) to take place before and after method step c) and/or at least in part simultaneously with method step c).

Preferably, the carrier or its extension in the liquid volume is arranged in such a way that in all volume elements of the solution the seed crystals in the crystallization insert are homogeneously, densely, finely distributed statically in the solution. This can be the case permanently, or by movement of the carrier in the process vessel.

Depending on the supersaturated concentration, seed crystals may be statically present in large numbers in each individual volume elements of 1 cm³. In principle, a surface provided with seed crystals, i.e. a crystallization surface, can be present in a range of 0.5 cm² to 5 cm² per 1 cm³ of the receiving volume at the crystallization insert for rapid crystallization in at least part of the receiving volume. It may be possible for the carrier to have a corresponding crystallization surface in each volume of the receiving vessel, or there may also be regions in the receiving volume in which the crystallization surface described above is not realized. Accordingly, it may be preferred that a crystallization surface of 0.5 cm² to 5 cm² per 1 cm³ of the receiving volume is present in at least part of the receiving volume.

The molecules can allocate themselves to the surface of the seed crystals faster and better by Van der Waals force in a still medium by diffusion without external influences than in a flowing solution. Accordingly, it may be preferable for the solution to be still for crystallization to occur. However, as described elsewhere, this is in no way mandatory.

Furthermore, in the crystallization process described here according to step d), the seed crystals can optionally be cooled while adjusting the temperature at the seed crystals to a temperature 12, where T2 is lower than T1. In other words, the crystallization insert or the carrier with the seed crystals is tempered in such a way that the temperature at the seed crystals has a lower temperature than the solution immediately after method step a).

Preferably, the temperature T2 of the seed crystals can be equal to or at most 5° C. lower than the temperature T1 of the solution, in particular the supersaturated solution or the solution depleted of the substance. For this purpose, the solution in the process vessel can be tempered, for which known tempering means can be used. In principle, the temperature T2 can preferably be at most 20° C., preferably at most 10° C., in particular preferably at most 5° C. below the temperature T1.

This can be realized in particular by directly tempering of the crystallization insert or the carrier. Thus, the crystallization insert or the carrier preferably has a tempering unit by means of which the seed crystals can be heated and/or cooled. This makes it possible for the crystallization insert or the carrier to be tempered directly, in particular independently of the tempering of the solution.

However, it is also possible within the scope of the invention to temper the solution in order to also temper the carrier or the seed crystals. In principle, however, it may be preferred that the temperature of the seed crystals is lower than that of the solution.

Following from the method steps described above, crystallization of the substance then takes place according to step e) on the seed crystals or on their surface and thus on the carrier. For example, through the temperature control specified above, the substance dissolved in the solution can come into contact with the comparatively cold carrier or with the comparatively cold seed crystals and thus precipitate in a crystallizing manner. In the process, the crystals grow on the carrier, so that the solution is diluted or depleted with respect to the substance.

Due to the fact that the seed crystals and subsequently also the crystallized substance are immobilized on the carrier, the substance can subsequently be advantageously isolated. In particular, the substance can thus be removed from the carrier and recovered in a highly pure form.

For this purpose, it is optionally provided according to method step f) that the formed crystals of the substance are isolated in the process vessel. It is thus possible to use a process vessel, as described in greater detail below, in which high-purity crystals of the substance are formed from the solution by appropriate method steps.

The process described allows substances to be removed from a solution and thus from a mixture of substances in an effective manner and thus to separate or isolate them. For example, the possibility of targeted temperature control allows the substance to be isolated from the solution in a defined and reproducible manner. This is possible in such a way that the substance is isolated as completely as possible, for example by setting a very low temperature. Alternatively, it is also possible to crystallize substances only to a limited extent, for example by selecting a comparatively high temperature. In this way, suitable conditions can always be created which allow the desired crystallization.

In addition, the process is highly adaptable to the substance to be isolated by using carriers with suitable seed crystals and appropriate temperatures. As a result, a wide variety of substances can be isolated from a solution in a targeted and effective manner without major reconstructions and with only minor modifications.

Adaptability can be further improved by the fact that a suitable temperature control adapted to suit the particular substance to be insulated is possible by tempering the carrier or seed crystals.

Furthermore, the process control can be made very adaptable by performing the process continuously or batchwise, as described in greater detail later.

For non-racemic separation, there is no risk of crystallization of the antipodes. The solution can therefore be cooled slowly, preferably homogeneously, with a steady reduction in temperature, whereby controlled crystallization on the seed crystals takes place from the supersaturated solution. Homogeneous cooling is preferably characterized by a temperature deviation of at most 1° C. throughout the whole solution. Crystallization on the carriers can be carried out, for example, by Ostwald ripening. In this case, crystallization is supported in particular by a temperature change of the solution. Preferably, the solution is heated for this purpose in such a way that a temperature change of the solution is increased quickly and briefly by a maximum of 2° C., whereby possibly small crystalline particles on the bottom and/or on the wall of the process vessel are brought into solution and their substance preferably attaches to larger crystalline particles on the carriers. In the end, the substance crystallizes completely from the solution in homogeneous crystallite size. This enables very high yields, for example in a range of at least 95% by weight, preferably at least 99% by weight, based on the theoretical yield of the substance originally present or dissolved in the solution.

Furthermore, by working up to the isolated crystal, a very simple construction can be chosen and the risk of contamination of the obtained crystals can be minimized. Therefore, a highly pure substance can be created by the process described here, which is of central importance for many different applications.

In order to isolate the crystals and thus when method step f) is implemented, the process may have the further method step:
f1) Detaching of substance crystallized on the seed crystals from the carrier inside the process vessel.

The method step f1) serves to isolate the crystals formed and, in particular, to have the crystals available in free form so that further method steps can follow and enable particularly effective purification.

For this purpose, for example, a scraper can be provided, whereby a relative movement is possible between the carrier and the scraper in order to mechanically loosen the crystals. In this case, the crystals initially remain in the solution and can then be removed from the solution and isolation can continue. However, other ways of removing the crystals from the support are also encompassed by the present invention. For example, the crystals can be detached from the support by centrifuging the process vessel, for example after separation of the free solution mass or free solvent, whereby the crystals are detached by the centrifugal force, while at the same time the residual solution adhering to crystallins is separated from the process vessel.

Thus, in realizing the method step f), the method may comprise the further method steps:
(f1) detaching substance crystallized on the seed crystals from the carrier within the process vessel; and
f2) removal of solution from the formed crystals;
f3) optionally, washing the crystals formed; and
f4) drying of the crystals.

To remove the solution from the crystals formed, it may be provided, for example, that the crystals produced are separated from the mass of free solution without a filter by draining the solution from the process vessel or, optionally, removing the crystallization insert, and decanting the solution from the process vessel.

For this purpose, for example, the process vessel can be centrifuged with or without a carrier. The solution protruding from the crystals can then be removed and, optionally, centrifugation can be repeated with the addition of further solvent. In this way, the crystals can be washed. Accordingly, at least one of the method steps f2) and f3) may comprise centrifuging the solution in the process vessel.

Particularly preferably, however, it can be provided that at least one of the method steps f2) and f3) comprises filtering the solution together with crystals present in the solution for collecting the crystals on the filter, in particular in the process vessel, wherein the filter can preferably be arranged in or at the process vessel. As a result, the solution may be decanted from the process vessel and the crystals may equally remain in the process vessel. For example, the filter may be arranged at or in an outlet of the process vessel.

In principle, however, it is also possible to remove the excess solution, for example by means of a syringe. This can be done both when removing the solution for the first time and during a washing or cleaning process.

This can be followed by drying of the crystals, so that the crystals can then be isolated. Drying of the crystals may be possible, for example, with a particularly high-purity gas stream or also using a vacuum.

Separation of the crystals from the support can also be realized by centrifugation, so that the same setup is possible for separating the crystals and for purifying the crystals.

In principle, at least one, for example both, of the method steps f2) and f3) can thus comprise at least one of a centrifuging and a filtering. For example, both of the method steps f2) and f3) can comprise a centrifuging and a filtering. This can simplify the process control and still allow a very effective cleaning of the crystals and thus obtaining high purity crystals.

After crystallization, the crystals produced can be separated from, for example, 90% of the solvent or free solution mass in a very short time, for example by decanting or draining the solution or removing the crystallization insert. This is possible much faster than with prior art processes and can reduce the risk of contamination of the mother liquor. In this step, the solution can thus be removed from the process vessel when the crystals formed are immobilized on the seed crystals, i.e. without centrifugation and/or filtration.

For example, a method may be performed by having the method steps:
(f1) detaching substance crystallized on the seed crystals from the carrier within the process vessel; and
f2) removal of solution from the formed crystals;
f3) optionally, purifying the crystals formed; and
f4) drying of the crystals, wherein
both of the method steps f2) and f3) comprise filtering the solution together with crystals present in the solution for collecting the crystals on the filter in the process vessel, the filter being arranged in or at an opening of the process vessel, a collecting vessel for collecting the solution or mother liquor being provided on the side of the filter opposite the receiving volume, and wherein
both of the method steps f2) and f3) comprise centrifuging the solution in the process vessel.

In an embodiment, an arrangement of a process vessel, a collecting vessel, and a filter unit comprising a filter may be used for separation, wherein the process vessel and the collecting vessel are attached to the filter unit in a fluid-tight manner and are fluidically interconnected through the filter such that solution is filtered through the filter from the process vessel into the collecting vessel under vacuum or centrifugal force, with solids being retained by the filter in the process vessel and separated from the solution.

Preferably, the method can be an enantiomer separation, wherein the substance is an enantiomer of a racemic mixture, in particular of a conglomerate-forming substance system, and the solution comprises the racemic mixture, in particular as a supersaturated solution of the racemate. In this embodiment, the process described herein can thus be used in particular to separate a racemate, in particular a conglomerate-forming substance system. This is advantageous for many technical processes, since racemates may be formed in chemical reactions, but often only one isolated enantiomer of the racemate or of the enantiomeric mixture is required. In particular, the crystallization process described here can be of great advantage for an enantiomer separation, since in particular conglomerates of an enantiomer mixture can often be separated by crystallization processes.

To isolate an enantiomer, it may be sufficient to use the carrier with one seed crystal at a time so that the desired enantiomer can be crystallized and isolated, but the other non-desired enantiomer remains in solution.

Insofar as both enantiomers are to be isolated, different carriers or different seed crystals of the enantiomers can be used, for example by successively using different carriers in a batch process in a process vessel by exchanging the crystallization insert or also in a continuous process by connecting different and interconnected or coupled process vessels with differently equipped crystallization inserts one after the other. For the separation and isolation of two enantiomers from a racemic mixture, such as in particular a conglomerate-forming substance system, the carrier of a first crystallization insert is, for example, loaded with the seed crystal of the first enantiomer, and the carrier of the second crystallization insert is loaded with the seed crystal of the second enantiomer. This is described in greater detail below.

For an enantiomer separation of a racemic mixture, especially a conglomerate forming system, isothermal crystallization is preferred. The crystallization time in batch process and the residence time in continuous process are depend on the degree of supersaturation. The residence time is preferably a maximum of 90 minutes, for example a maximum of 60 minutes, particularly preferably a maximum of 30 minutes. By this, an enantiomeric excess of more than 90%, preferably more than 95%, particularly preferably more than 99% can be achieved.

The ideal residence time for optimal separation for the cleavage of racemates can be determined with pinpoint accuracy by measuring the rotational value of the solution in the method, wherein at the inflection point of the rotational value, crystallines on carriers can be rapidly separated from the solution.

With regard to the crystallization temperature, which is set in method step d), it should be noted that this should be selected in such a way that only the desired enantiomer crystallizes out on the seed crystals, but the antipode remains in solution.

It may be further preferred that the method steps a) to e) are carried out as a common sequence repetitively in a process vessel, wherein between two repeating sequences the crystallization insert of the process vessel is exchanged, wherein in a first sequence the carrier comprises a first type of seed crystals and wherein in a second sequence the carrier comprises a second type of seed crystals different from the first type.

In this embodiment, more than one substance can thus be isolated from the solution. It is thus possible, for example from a mixture of dissolved substances, to perform a separation in such a way that the respective dissolved substances are isolated individually in crystallized form. This can be achieved by equipping the carrier or different carriers used in succession with different seed crystals on which the substance to be isolated is selectively crystallized.

In particular, this embodiment can form a so-called batch process.

Alternatively or additionally, it is also possible to perform a separation of different substances from the solution in a continuous process. In this case, the method steps a) to e) can be carried out as a common sequence repetitively in different process vessels, wherein the carrier of a first process vessel comprises a first type of seed crystals and wherein the carrier of a second process vessel, connected in particular downstream of the first process vessel and connected or coupled to the first process vessel by a fluid connection, has a second type of seed crystals different from the first type.

Thus, the solution is first conveyed into a first process vessel and can remain there until a desired amount of a first substance crystallizes on the carrier or its seed crystals located in the first liquid container. Subsequently, the solution, which is supersaturated in particular with respect to the second substance, can be conveyed into a second process vessel, where a carrier with another seed crystal is provided. Here, too, the solution can again remain until a desired amount of a second substance crystallizes out on the carrier located in the first process vessel or its seed crystals. This can be realized, for example, continuously at an adjustable flow rate.

Thus, in this embodiment, it is provided in particular that the discharge line of a first process vessel is connected to the feed line of a second process vessel and the process vessels are thus coupled to one another. In the connection between the first and second process vessels, one or a plurality of further process vessels can be provided, into which a saturated substance mixture solution can be introduced,

In principle, at least two coupled process vessels are thus operated simultaneously and continuously, with different seed crystals of, for example, the enantiomeric antipodes of a racemate being immobilized on the carrier in both process vessels.

Thus, solution mixtures can be separated in an effective and easy-to-perform manner. Two different substances can be isolated both in a batch process and in a continuous process, or more than two substances can be isolated if a larger number of carriers are used.

The advantage of a continuous process is further that there is no or very little danger of the two process vessels being contaminated by each other, since there are no fine crystal particles floating in the solution. The danger can be further reduced by providing a filter.

In an exemplary embodiment, the method can proceed as follows, whereby all of the following steps or substeps can also be part of the method in a stand-alone position or in combination with other steps:
A) the solution free of formed crystals is discharged from the process vessel, for example by at least one of
A1) decanting through an outlet of the process vessel, in particular with the crystallization insert in place,
A2) removing the crystallization insert and decanting the solution through an opening that becomes free as a result;
A3a) centrifuging the process vessel with crystallization insert and optionally applying vacuum to the process vessel; wherein the process vessel, the lid of which is or will be equipped with a filter insert with filter disk, is tightly closed, and wherein, when centrifuging, the process vessel with opening downward is inserted into a centrifuge and centrifuged, whereby likewise the crystals detach from the crystallization insert by centrifugal force, and the crystals are freed from adhering solution by passing the solution through the filter; wherein
A3b) optionally, an arrangement is used in the centrifugation, the arrangement comprising the process vessel, a collecting vessel and a filter unit with a filter, the process vessel and the collecting vessel being fluid-tightly attached to the filter unit and fluidically connected to each other through the filter such, that solution is filterable from the process vessel into the collecting vessel under vacuum or centrifugal force through the filter, solid matter being retained by the filter in the process vessel and separated from the solution.
B) the crystals are optionally removed from the crystallization insert in a further step.
C) the crystallization insert freed from crystals can be removed from the process vessel.
D) The crystals are washed and dried in the same process vessel.

With respect to further technical features and advantages of the method, reference is hereby made to the description of the crystallization arrangement, the use, the arrangement the examples, the figures and the description of the figures, and vice versa.

Further described is a crystallization arrangement for crystallizing at least one substance from a solution, in particular for carrying out a process as described above, comprising a process vessel for receiving the solution and comprising a crystallization insert with at least one carrier for insertion into the process vessel, wherein the surface of the carrier is provided with seed crystals for the substance for crystal growth such, that the seed crystals are immobilized on the surface of the carrier of the crystallization insert, and wherein at least one carrier has a spiral shape, wherein the process vessel comprises a receptacle for receiving the crystallization insert with the carrier, wherein the crystallization insert is non-destructively detachable from the receptacle, and wherein the crystallization insert is further positionable in the receptacle such, that the seed crystals are contactable with the solution.

Such a crystallization device can in particular be used to carry out a described crystallization process and it thus serves in particular to crystallize at least one substance from a solution.

For this purpose, the crystallization arrangement comprises a process vessel for receiving the solution in which the substance is located. The process vessel of the crystallization arrangement is basically selectable insofar as the process described here can be carried out with it. Advantageous materials include in particular non-oxidizing materials, such as glass or plastics, or non-oxidizing metals, for example stainless steel or enameled metals. In principle, the material of the process vessel and any other components coming into contact with the solution should be inert to the solution and in particular to the substance.

Further, the crystallization arrangement comprises a crystallization insert having at least one carrier for insertion into the process vessel, the surface of the carrier being provided with seed crystals for the substance for crystal growth such that the seed crystals are immobilized on the surface of the carrier of the crystallization insert.

Thus, the carrier or the seed crystals are advantageously adapted to the process to be carried out or to the substance to be isolated. Such a carrier can in particular be designed and manufactured as described above with reference to the process and the seed crystals can further be immobilized in such a way that substance crystallized on the carrier can be detached from the carrier while the seed crystals remain immobilized.

Particularly preferably, the carrier has a spiral shape, whereby in particular an Archimedean spiral shape can be provided. Such a shape allows particularly effective a homogeneous distribution of the seed crystals in the solution across the separation, for example when the carrier is rotated in the process vessel or when the carriers are rotated in the process vessel, or also when the carrier is stationary in the process vessel, the latter being supported by the spiral shape.

Particularly preferably, the carrier is designed in, for example, an Archimedean spiral shape, for example made of rigid foil, the distances between the spiral shape, i.e. between the respective winding regions, being less than 2 cm, preferably less than 1 cm, in particular preferably less than 0.5 cm. A hard foil can further be understood to be a foil which is so stable that the spiral form retains its shape under the process temperature and when the crystalline material is carried on the surfaces, even if the spiral form stands empty without external influences.

Alternatively or additionally, it may be preferred that the carrier is designed as a foil or fabric, the foil or fabric preferably being provided with through-openings. This design allows the solution to flow effectively around seed crystals immobilized on the carrier, thus enabling particularly effective crystallization of the substance from the solution.

With regard to a positioning of the crystallization insert, the process vessel has a receptacle for receiving the crystallization insert with the carrier. The carrier can further be detached from the receptacle in a non-destructive manner, which enables a preferred applicability that the process vessel and the carrier can be used multiple times. The receptacle may allow a defined position of the crystallization insert and further ensure that the crystallization insert is stably secured.

Furthermore, the carrier is positioned or can be positioned in the holder in such a way that the seed crystals can be brought into contact with the solution. Bringing into contact can mean both immersion of the carrier in the solution and also a possible pouring over or immersion of the carrier in the solution, as described in greater detail above with reference to the process.

Furthermore, it is preferred that a temperature control unit is provided for direct or indirect tempering of the carrier and thus of the seed crystals. For example, the solution in the process vessel can be tempered, whereby the carrier or the seed crystals can thus be tempered indirectly.

For direct tempering of the carrier, the carrier can, for example, have one or more channels through which a corresponding, in particular liquid, temperature control medium can be passed in order to temper the carrier, in particular to cool it. In this case, the channel or channels can be connected to a cooling and/or heating unit which adjusts the temperature control medium to a temperature by means of which the carrier can be tempered as desired or that the temperature of the carrier and thus of seed crystals immobilized on the carrier for crystal growth of the substance can be set in a defined manner.

For example, in particular, the solution in the container and/or the carrier can be tempered separately.

In the crystallization arrangement described herein, it may further be provided in an embodiment that the crystallization arrangement comprises a filter for filtering solution present in the process vessel, or that the crystallization arrangement comprises a centrifuge for centrifuging the process vessel. For example, it may be advantageous if the process vessel comprises a filter for filtering solution present in the process vessel, and if the crystallization arrangement comprises a centrifuge for centrifuging the process vessel.

With regard to the filter, this can be positioned at a liquid outlet of the process vessel, for example. This filter can prevent solution discharged from the liquid outlet from entraining formed crystals, which would then potentially be lost or need to be further isolated. This can be independent of whether the solution is dumped, for example, or returned to the vessel or fed to another carrier in a coupled process vessel. Thus, the filter serves in particular to separate the crystals from the solution and accordingly to isolate the crystals.

The filter or filtration insert is thus designed for the passage of the liquid medium and the retention of the crystals produced. It can be designed as a filtration disc, or filter screen, or filter cloth, or filter foil or filter paper, or other materials known to the skilled person having such a function. The mesh size may be selected based on the desired crystal size to be obtained.

For example, after removal of the free solvent mass, the lid of the process vessel can be fitted with a filter unit and the container positioned on a centrifuge like a conventional centrifuge bottle, but with the opening facing downwards, so that the adhered residual solvent is centrifuged out of the container through the filter. The crystallines produced are thereby detached from the carrier by the centrifugal force.

The centrifuge can also serve to isolate the crystals in the process vessel. In this respect, it should be mentioned that the vessel can be connectable to the centrifuge. For example, the process vessel can be cylindrical and/or have a wide-necked opening, in particular at which the filter is arranged and at which, for example, the centrifuge or a vacuum pump, as described below, can be arranged.

Centrifugation can, for example, detach the crystals from the carrier or seed crystals or remove the supernatant solution from the process vessel. This can be done without or preferably with a filter. In this regard, it may further be advantageous that a collection volume is provided in the process vessel for collecting crystals that settle during centrifugation of the process vessel. In this embodiment, the solution may be centrifuged together with crystals detached from the carrier, thereby separating the crystals from the solution. For example, the collection volume may be a region of reduced diameter, such as a V-shaped tapered region. For example, the solution may be discharged through the filter by centrifugation.

Further preferably, the crystallization arrangement can have at least one of a vacuum pump and a protective gas source, wherein the process vessel can be connected to the protective gas source or the vacuum pump in such a way that a protective gas flow can be passed through the process vessel or that a vacuum can be applied in the process vessel. In this embodiment, particularly advantageous drying of the crystals formed can be made possible, since any solvent adhering to the crystals can be entrained by a stream of inert gas passed through the process vessel. Furthermore, the solvent can evaporate due to the vacuum.

For the purposes of the present invention, inert gas means a gas which does not react with the crystallized substance and is therefore inert in this respect, for example argon or nitrogen.

The outlet of the protective gas flow or the connection of the vacuum pump can preferably be arranged at the filter of the process vessel, as this prevents crystals formed from being discharged from the process vessel.

Furthermore, it may be advantageous that a mixing device is provided for mixing the solution in the process vessel. Such a device may in particular be an agitator or also a device for introducing waves, such as sound waves, into the solution. Furthermore, the carrier in the vessel may also be movable, such as rotatable. This can enable the solution to move relative to the carrier, which in turn can significantly improve the crystallization of the solution on the carrier.

Preferably, the process vessel can have at least one liquid inlet and a liquid outlet different from the liquid inlet. In this embodiment, a continuous process using two coupled process vessels can be particularly advantageous. This is because solution depleted with respect to the crystallized substance can be removed through the outlet, whereas further solution can be added through the inlet. Downstream of the outlet, the solution can either be discarded, fed to the inlet again, or fed to another process vessel, in particular a coupled one, in which a further substance is to be crystallized out.

It is further encompassed by the invention that the crystallization arrangement comprises more than two process vessels. In this case, the carriers may in turn have, in particular, seed crystals on the carriers that are different from one another, and the process vessels may be connected to one another by a fluid connection and thus coupled to one another.

In particular, it may be provided that the crystallization arrangement comprises at least two process vessels, wherein the at least two process vessels are connected in series, and wherein the carriers of the process vessels are provided with seed crystals different from each other.

In this embodiment, the two process vessels provided can be used in particular to isolate not only one substance from the solution, but to remove two substances from the solution by crystallization. This can be done in a continuous process in such a way that the solution is first filled into the process vessels of the first crystallization arrangement and there the substance crystallizes out on the corresponding carrier or on the seed crystals. Subsequently, the solution can be transferred to the second process vessel, where it comes into contact with the seed crystals of the second carrier.

Subsequently, the crystals can be removed from the carrier or seed crystals and isolated as described in the method.

The above-described embodiment thus effectively enables the crystallization process described to be carried out and thus also the advantages described above, in particular with regard to effective isolation of substances present in the solution.

Thus, for example, a crystallization arrangement for crystallizing and separating at least one substance from a solution, in particular for carrying out a method as described above, is described, comprising a process vessel, in particular a cylindrical process vessel, for receiving the solution, wherein the process vessel has a receptacle for receiving a carrier, wherein the carrier is provided with seed crystals immobilized on the carrier for the substance and is detachable from the receptacle in a non-destructive manner, and wherein the carrier is further positionable in the receptacle in such away that the seed crystals can be brought into contact with the solution, wherein further preferably a tempering unit is provided for directly or indirectly tempering the seed crystals, and wherein
the crystallization arrangement comprises a filter for filtering solution present in the process vessel, or wherein
the crystallization arrangement has a centrifuge for centrifuging the process vessel.

With respect to further technical features and advantages of the crystallization arrangement, reference is hereby made to the description of the method, the use, the arrangement, the examples, the figures and the description of the figures, and vice versa.

Exemplary is further provided a use of at least one crystallization method and crystallization arrangement as described above for an enantiomer separation of a racemic mixture.

In this embodiment, in particular a racemate, preferably a conglomerate-forming substance mixture or substance system, can be separated. This is advantageous for many technical processes, since racemates may be formed in chemical reactions, but often only one isolated enantiomer of the racemate or enantiomer mixture is required. In particular, the crystallization process described here can be of great advantage for an enantiomer separation, since enantiomers can often be separated by crystallization processes.

To isolate an enantiomer, it may be sufficient to use the support with one seed crystal at a time so that the desired enantiomer can be crystallized and isolated.

To the extent that both enantiomers are to be isolated, different carriers or different seed crystals can be used, for example by successively using different supports in a batch process or also in a continuous process, as described in greater detail above.

It has been shown that the crystallization arrangement, the method and the crystallization arrangement as described above are particularly well suited to effectively and in a defined manner isolate the individual enantiomers separately from each other and highly selectively and thus perform enantiomer separation.

With respect to further technical features and advantages of use, reference is hereby made to the description of the crystallization process, the crystallization arrangement, the arrangement, the examples, the figures and the description of the figures, and vice versa.

Further described is an arrangement of a process vessel, a collecting vessel and a filter unit comprising a filter, wherein the process vessel and the collecting vessel are attached to the filter unit in a fluid-tight manner and are fluidically connected to each other through the filter in such a way that solution can be filtered from the process vessel into the collecting vessel through the filter under vacuum or centrifugal force, wherein solid is retained by the filter in the process vessel and separated from the solution.

Such an arrangement allows in a particularly advantageous way that filtration is possible without or at least with significantly reduced risk of contamination of filtrate. In addition, a particularly simple applicability can be given, since the process vessel can be connected to the filter unit and the collecting vessel in a simple manner, for example after removing the lid.

Particularly advantageously, the process vessel and the collecting vessel can arranged in the same manner. In this embodiment, the collecting vessel can also be used as a process vessel using a crystallization insert.

For easy assembly and disassembly, detachable fastenings of the process vessel or collecting vessel to the filter unit are also preferred. Examples include screw connections, clamp connections and the like.

With respect to further technical features and advantages of the arrangement, reference is hereby made to the description of the crystallization process, the crystallization arrangement, the use, the examples, the figures and the description of the figures, and vice versa.

The following is an exemplary explanation of the invention with reference to the accompanying figures, wherein the features shown below may each individually or in combination constitute an aspect of the invention, and wherein the invention is not limited to the following drawing, the following description, and the following embodiment.

### It is Shown:

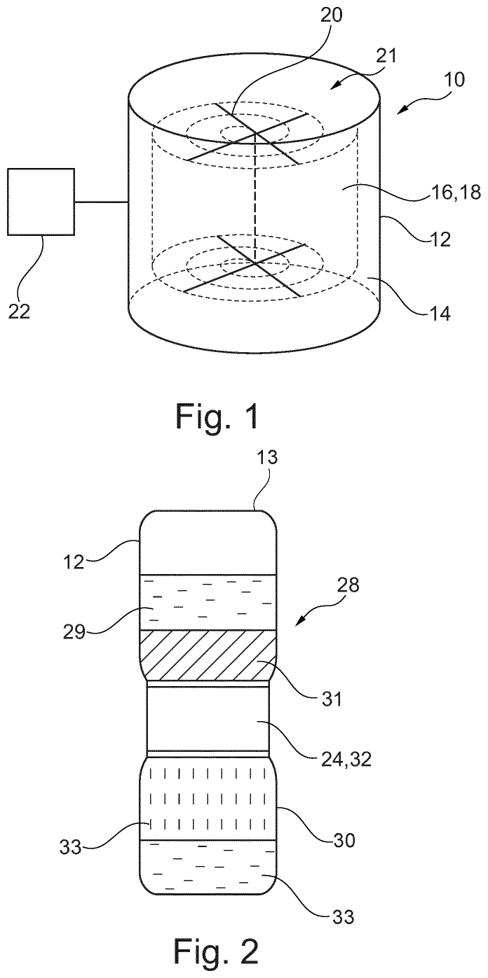

FIG. 1 shows schematically a crystallization arrangement according to the present invention;

FIG. 2 shows schematically an arrangement for centrifuging the solution:

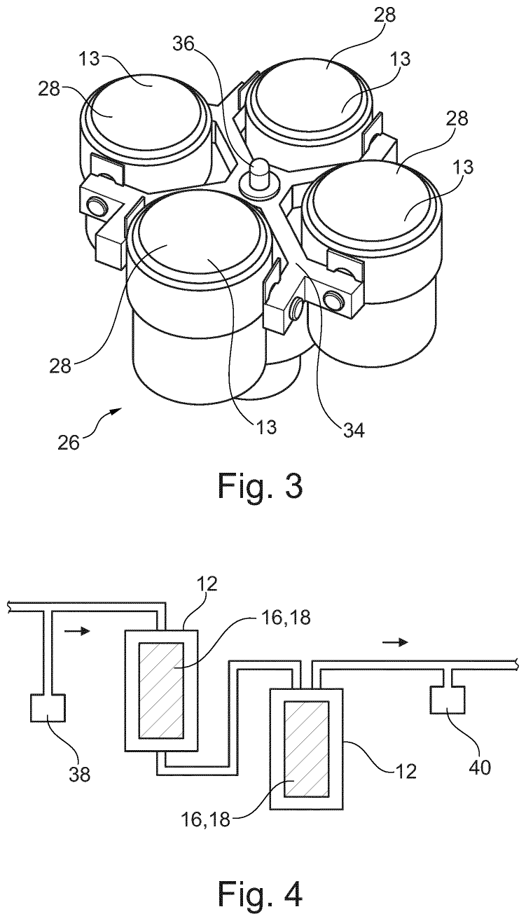

FIG. 3 shows a centrifuge for a crystallization arrangement according to the present invention; and

FIG. 4 shows a setup for continuous crystallization and separation of various substances from a solution.

In FIG. 1, a crystallization arrangement 10 for crystallizing at least one substance from a solution is shown schematically and in part.

The crystallization arrangement 10 comprises a process vessel 12, which according to FIG. 1 is designed as a cylindrical process vessel. The process vessel 12 serves to receive the solution and thus the substance dissolved in the solution. Furthermore, the process vessel 12 comprises a receptacle 14 for receiving a carrier 16 or a crystallization insert comprising the carrier 16. In particular, the receptacle 14 is an internal volume of the process vessel 12 such that the carrier 16 can be disposed within the process vessel 12. The carrier 16 is further provided with seed crystals Ig immobilized on the carrier 16 for the substance, and is non-destructively detachable from the receptacle 14. The carrier 16 is further positioned in the receptacle 14 such that the seed crystals 18 are contactable with the solution. This is shown in FIG. 1, wherein a holder 20 is further provided for the carrier 16, by means of which the carrier 16 can be brought into and removed from the receptacle. The carrier 16 together with the holder 20 form the crystallization insert 21.

It is further shown that the carrier 16 is formed in an Archimedean spiral shape. In the form shown in FIG. 1, the carrier 16, which may in particular be formed from a rigid foil, is dimensionally stable under the working or separating conditions. The latter is basically advantageous for the carrier 16, regardless of the specific shape. This enables the carrier 16 or the seed crystals 18 to be effectively flowed around by the solution and thus the substance can effectively crystallize out on the seed crystals 18. Such an embodiment provides a dense, homogeneous and static distribution of the seed crystals 18 and thereby a fast and homogeneous crystallization.

The process vessel 12 can be tempered by methods known to those skilled in the art.

To enable crystallization to take place effectively, a temperature control unit 22 is also provided for directly or indirectly controlling the temperature of the carrier 16 and the seed crystals 18, respectively. In the embodiment according to FIG. 1, a temperature control unit 22 is shown schematically, which acts on the solution and thus indirectly tempers the carrier 16 and the seed crystals 18.

The crystallization arrangement 10 shown further comprises at least one of a filter 24 for filtering solution present in the process vessel 12, in particular for removing solution adhering to crystals, and a centrifuge 26 for centrifuging the process vessel 12. In this way, it can be made possible in a particularly advantageous manner for the crystals formed to be isolated, for example washed and dried, in the process vessel 12. More specifically, it is provided that the crystallization arrangement 10 comprises a filter 24 for filtering solution present in the process vessel 12, and that the crystallization arrangement 10 comprises a centrifuge 26 for centrifuging the process vessel 12.

FIG. 2 shows an arrangement 28 by means of which the process vessel 12 can be centrifuged in a particularly advantageous manner. In addition to the process vessel 12, a collecting vessel 30 is provided, wherein a filter unit 32 with a filter 24 is provided between the process vessel 12 and the collecting vessel 30. If this arrangement 28 is now centrifuged in a centrifuge 26, the crystals formed are retained by the filter 24 and the further solution passes through the filter 24 and can be collected in the collecting vessel 30. Thus, the separation of the crystals from the solution can be accomplished exceptionally rapidly and free of contamination. Particularly for the cleavage of racemates, such as in particular for conglomerate-forming systems, separation can be carried out with pinpoint accuracy with respect to the rotation value.

In this regard, it is shown in FIG. 2 that a filter cake 31 of crystals retained on the filter is formed on the filter 24, with the solution passing through the filter 24 as filtrate 33 and collecting in the collecting vessel 30, the filter cake 31 or crystals can then be isolated.

FIG. 3 shows a centrifuge 26 in which four assemblies 28 are provided with process vessels 12. The assemblies 28 are pivotally mounted to a motor of the centrifuge 26 on mounting arms 34, the mounting arms 34 being rotatable by a drive hub 36 of the motor to permit centrifugation. It should be noted that the upper portion shown in FIG. 3 is the bottom 13 of the process vessel 12 to allow effective removal of solution from the process vessel 12, as also shown in FIG. 2.

By means of the above-described crystallization arrangement 10, a crystallization method for crystallizing and separating a substance from a solution in which the substance is present, in particular supersaturatedly dissolved, can be carried out, comprising the method steps:
a) introducing the solution comprising the substance into a receiving volume of a process vessel 12 of a crystallization arrangement 10, the solution having a temperature T1 after the introduction;
b) providing a crystallization insert 21 having at least one carrier 16 for insertion into the process vessel 12, wherein the surface of the carrier 16 is provided with seed crystals of a substance for crystal growth such, that the seed crystals 18 are immobilized on the surface of the carrier 16 of the crystallization insert 21 and wherein at least one carrier 16 has a spiral shape,
c) positioning the crystallization insert 21 in a receptacle 14 of the crystallization arrangement 10 in such a way, that the carrier 16 can be brought into contact with the solution,
d) optionally cooling the seed crystals 18 while adjusting the temperature at the seed crystals 18 to a temperature T2, where T2 is less than T1,
e) crystallization of the substance on the surface of the seed crystals 18, and
f) optionally, isolating the formed crystals of the substance in the process vessel (12).

Using the arrangement described above, in addition to the possibility of isolating a substance from the solution, different substances present in the solution can also be isolated separately. For this purpose, the solution can be treated successively with carriers 16 having different seed crystals 18.

For example, once the solution has been collected in the collecting vessel 30 of the arrangement 28, it can be reintroduced into a process vessel 12 in which the carrier 16 or seed crystals 18 have been modified after a first process of crystallization. Subsequently, the same process may be carried out again.

This can be done more easily if the process vessel 12 and the collecting vessel 30 are of identical construction. In this case, another crystallization insert 21 can be inserted into the solution, which has other seed crystals 18.

Alternatively, the crystallization arrangement 10 may comprise at least two coupled process vessels 12, wherein the at least two process vessels 12 are connected in series, and wherein the carriers 16 of the process vessels 12 are provided with mutually different seed crystals 18. This embodiment is shown in FIG. 4. In this embodiment, a continuous process is possible by slowly passing the solution through both process vessels 12. As a result, the different substances crystallize on the different carriers 16 and the different seed crystals 18, respectively. Thus, separate isolation without the risk of contamination is possible in a particularly efficient manner.

An inert gas source 38 may be provided upstream of the first process vessel 12, by means of which crystals formed in the process vessel 12 may be dried. Alternatively or additionally, a vacuum pump 40 may be provided downstream of the second process vessel 12. This can also be used to remove solvent residues adhering to the crystals and thus dry the crystals.

### EXAMPLES

In the following examples, the production of seed crystals on a carrier 16 is shown first. Subsequently, a racemate separation is carried out with the correspondingly produced carriers 16.

### Production of Seed Crystals on Carriers

### Preparation of L-Threonine Seed Crystals on Supports 16:

A solution of L-threonine saturated at 60° C. in water is prepared in a cylindrical process vessel 12 with a screw cap and cooled to 35° C. A crystallization insert 21 with an Archimedean spiral carrier 16 made of PP rigid foil, with spacing between spirals of about 3 mm, is briefly immersed in the solution and dried briefly after separation from the solution. The procedure was repeated a few times until obtaining a surface covered with seed crystals thinly homogeneously distributed. The crystallization insert 21 thus produced is used with the L-threonine seed crystals produced in a subsequent separation.

### Preparation of D-Threonine Seed Crystals on Supports 16:

A solution of D-threonine saturated at 60° C. in water is prepared in a cylindrical round-bottomed flask with screw cap and cooled to 35° C. A crystallization insert 21 with an Archimedean spiral carrier 16 made of PP rigid foil, with spacing between spirals about 3 mm, is briefly immersed in the solution and dried briefly after separation from the solution. The procedure was repeated a few times until obtaining a surface covered with seed crystals thinly homogeneously distributed. The crystallization insert 21 thus produced is used with the generated D-threonine seed crystals in a subsequent separation.

Batch Separation of DL-Threonine by Preferential Crystallization with Seed Crystals on Supports 16.

### 1.1 L-Threonine:

A solution of the racemic mixture of DL-threonine in water, saturated at 50° C. is introduced with stirring into a process vessel 12, namely a cylindrical round-bottomed flask with a screw cap, and stirred at 55° C. for 60 minutes. The solution is cooled to 35° C., and the stirrer is turned off. A crystallization insert 21 as described above containing L-threonine seed crystals, the crystallization insert 21 having the same temperature of 35° C. as the solution, is carefully positioned in the solution. The solution is held at this temperature for 45 minutes. The supersaturated L-threonine in the solution crystallizes statically on the surface of the seed crystals. After 45 minutes, the crystallization insert 21 containing the crystallins is removed from the solution and transferred to a centrifuge container and centrifuged for 3 minutes via a 2-bottle system with a filter insert positioned in between. The solution adhered to the crystallins is collected in the lower bottle. The L-threonine obtained is dry and has an enantiomeric excess of >99% ee.

### 1.2 D-Threonine:

The solution collected and filtered from 1.1 in the lower flask is mixed with the residual solution in the process vessel 12 from experiment 1.1 and stirred at 55° C. for 60 minutes, then cooled to 35° C. The stirrer is turned off. A crystallization insert 21 as described above containing D-threonine seed crystals, with its temperature being the same as the solution temperature of 35° C., is carefully positioned in the solution. At this temperature, the supersaturated D-threonine crystallizes statically on the surface of the seed crystals. After 45 minutes, the solution is decanted. A centrifuge container is tightly and firmly connected to the opening of the process vessel 12 by a threaded connection with a filter assembly placed in between. The solution adhered to the crystallins is centrifuged and collected in the lower flask. The D-threonine obtained has an enantiomeric excess of >99% ee.

Continuous Separation of DL-Threonine by Preferential Crystallization with Seed Crystals on Support 16.

A supersaturated solution of the racemic mixture in water, saturated at 50° C., and tempered to 38° C. is introduced separately into 2 process vessels 12 A and B. A crystallization insert 21 containing L-threonine seed crystals, also tempered to 38° C., is carefully positioned in the solution of the process vessel 12 A. At the same time, a crystallization insert 21 containing D-threonine seed crystals, which has been tempered to 38° C. is carefully positioned in the solution of process vessel 12 B. A solution of the racemic mixture in water saturated at 50° C. and tempered to 38° C. is continuously introduced into process vessel 12 A. From process vessel 12 A, the solution is discharged into process vessel B at the same speed. From process vessel 12 B, the solution flows at the same speed into process vessel 12, where the supersaturated solution of the racemic mixture in water saturated at 50° C., and tempered to 38° C. is prepared. Process vessels 12 A and B are tempered to 38° C. After 3 hours, both process vessels 12 A and B are centrifuged as in experiment 1.2. The isolated L-threonine and D-threonine each have an enantiomeric excess of >99% cc.

The present invention thus makes it possible to provide a method and a device which are able to overcome at least in part the disadvantages of the prior art. The homogeneously finely distributed seed crystals, in particular in all volume elements of the solution, of a substance, in particular of an enantiomer, should appear immobilized statically on carrier surface, and not, as described in the prior art, as a crystal suspension. This allows crystallization to occur rapidly on the densely, homogeneously finely distributed surface of the seed crystals. The crystals obtained can be large and homogeneous with respect to size, and can be quickly and completely mechanically separable from the solution. Furthermore, highly pure substances can be obtained.

### REFERENCE SIGNS

10 crystallization arrangement
12 process vessel
13 floor
14 receptacle
16 carrier
18 seed crystals
20 holder
21 crystallization insert
22 temperature control unit
24 filter
26 centrifuge
28 arrangement
30 collecting vessel
31 filter cake
32 filter unit
33 Filtrate
34 mounting arm
36 drive hub
38 inert gas source
40 vacuum pump

1: A method for crystallizing and separating a substance from a solution in which the substance is present, and in particular is dissolved supersaturated, the method comprising the steps of:
a) introducing the solution comprising the substance into a receiving volume of a process vessel (12) of a crystallization arrangement (10), the solution having a temperature T1 after introduction;
b) providing a crystallization insert (21) with at least one carrier (16) for insertion into the process vessel (12), wherein the surface of the carrier (16) is provided with seed crystals (18) for the substance for crystal growth in such a way that the seed crystals (18) are immobilized on the surface of the carrier (16) of the crystallization insert (21), and wherein at least one carrier (16) has a spiral shape;
c) positioning the crystallization insert (21) in a receptacle (14) of the crystallization device (10) in such a way that the carrier (16) can be brought into contact with the solution;
d) optionally cooling the seed crystals (18) while adjusting the temperature at the seed crystals (18) to a temperature T2, wherein T2 is lower than T1;
e) crystallization of the substance on the surface of the seed crystals (18); and
f) optionally, isolating the formed crystals of the substance in the process vessel (12).

2: The method according to claim 1, wherein a crystallization surface of 0.5 cm² to 5 cm² per 1 cm³ of the receiving volume is present in at least part of the receiving volume.

3: The method according to claim 1, wherein the method comprises method step f) and method step f) comprises the method steps:
f1) detaching substance crystallized on the seed crystals (18) from the carrier (16) within the process vessel (12);
f2) removing of solution from the formed crystals;
f3) optionally cleaning the formed crystals; and
f4) drying of the crystals.

4: The method according to claim 3, wherein at least one of the method steps f2) and f3) comprises filtering the solution together with crystals present in the solution for collecting the crystals on a filter (24), in particular in the process vessel (12).

5: The method according to claim 1, wherein an arrangement (28) of a process vessel (12), a collecting vessel (30) and a filter unit (32) comprising a filter (24) is used for separation, wherein the process vessel (12) and the collecting vessel (30) are attached to the filter unit (32) in a fluid-tight manner and are fluidically connected to each other through the filter (34) such that solution is filtered through the filter (24) from the process vessel (12) into the collecting vessel (30) under vacuum or centrifugal force, wherein solids are retained in the process vessel (12) by the filter (24) and separated from the solution.

6: The method according to claim 1, wherein the method is an enantiomer separation, wherein the substance is an enantiomer of a racemic mixture and the solution comprises the racemic mixture.

7: The method according to claim 1, wherein the method steps a) to e) are carried out as a common sequence repetitively in a process vessel (12), wherein between two repeating sequences the crystallization insert (21) of the process vessel (12) is exchanged, wherein in a first sequence the carrier (16) comprises a first type of seed crystals (18) and wherein in a second sequence the carrier (16) comprises a second type of seed crystals (18) different from the first type.

8: The method according to claim 1, wherein the method steps a) to e) are carried out as a common sequence repetitively in different process vessels (12), wherein the carrier (16) of a first process vessel (12) comprises a first type of seed crystals (18) and wherein the carrier (16) of a second process vessel (12) comprises a second type of seed crystals (18) different from the first type.

9: The method according to claim 1, wherein method step a) is carried out at least in part before method step c).

10: The method according to claim 1, wherein method step a) is carried out at least in part after method step c).

11: A crystallization arrangement (10) for crystallizing at least one substance from a solution, in particular for carrying out a method according to claim 1, the crystallization arrangement comprising a process vessel (12) for receiving the solution and comprising a crystallization insert (21) having at least one carrier (16) for insertion into the process vessel (12), wherein the surface of the carrier (16) is provided with seed crystals (18) for the substance for crystal growth such, that the seed crystals (18) are immobilized on the surface of the carrier (16) of the crystallization insert (21), and wherein at least one carrier (16) has a spiral shape, wherein the process vessel (12) comprises a receptacle (14) for receiving the crystallization insert (21) with the carrier (16), wherein the crystallization insert (21) is non-destructively detachable from the receptacle (14), and wherein the crystallization insert (21) is further positionable in the receptacle (14) such, that the seed crystals (18) are contactable with the solution.

12: The crystallization arrangement (10) according to claim 11, wherein the crystallization arrangement (10) comprises a filter (24) for filtering solution present in the process vessel (12).

13: The crystallization arrangement according to any claim 11, wherein the carrier (16) is designed as a foil or fabric.

14: The crystallization arrangement according to claim 13, wherein the foil or the fabric is provided with through-openings.

15: An arrangement (28) comprising a process vessel (12), a collecting vessel (30) and a filter unit (32) comprising a filter (24), wherein the process vessel (12) and the collecting vessel (30) are attached to the filter unit (32) in a fluid-tight manner and are fluidically connected to each other through the filter (24) in such a way, that solution can be filtered from the process vessel (12) into the collecting vessel (30) through the filter (24) under vacuum or centrifugal force, wherein solid is retained by the filter (24) in the process vessel (12) and is separated from the solution.
